(19) United States
(12) Patent Application Publication
(10) Pub. No.: US 2011/0100166 A1
(43) Pub. Date: May 5, 2011

(54) T-HANDLE WRENCH

(76) Inventor: Hrayr Darbinyan, Yerevan (AM)

(21) Appl. No.: 12/916,250

(22) Filed: Oct. 29, 2010

Related U.S. Application Data
(60) Provisional application No. 61/256,137, filed on Oct. 29, 2009.

(51) Int. Cl. B25B 13/28; B25B 23/16

(52) U.S. Cl. 81/90.1; 81/177.5

(57) ABSTRACT

The present invention generally relates to a T-Handle wrench. In one aspect, a wrench is provided that includes a shaped handle. The wrench further includes a plurality of jaws operatively attached to the handle. The wrench also includes a sleeve member disposed around the jaws. Additionally, the wrench includes a push button assembly configured to move the sleeve member relative to the jaws, wherein the movement of the sleeve member causes the jaws to move between a retracted position and an extended position. In another aspect, a method of operating a wrench is provided.

### CROSS-REFERENCE TO RELATED APPLICATIONS

This application claims benefit of U.S. provisional patent application Ser. No. 61/256,137, filed Oct. 29, 2009, which is herein incorporated by reference.

### BACKGROUND OF THE INVENTION

1. Field of the Invention

Embodiments of the present invention generally relate to a ratchet wrench. More particularly, the present invention relates to a T-Handle wrench.

2. Description of the Related Art

A conventional ratchet wrench includes a wrench head attached to a handle. The wrench head includes a shaft configured to receive a socket. The socket is used to engage an object, such as a bolt head. Generally, the socket is used for a single sized bolt head. The conventional ratchet wrench also includes a grip and slide mechanism configured to allow the wrench head and the socket to rotate relative to the handle in a first direction and remain fixed relative to the handle in a second direction. Even though the conventional ratchet wrench may be useful in rotating the bolt head, there is still a need for an improved ratchet wrench.

### SUMMARY OF THE INVENTION

The present invention generally relates to a T-Handle wrench. In one aspect, a wrench is provided that includes a shaped handle. The wrench further includes a plurality of jaws operatively attached to the handle. The wrench also includes a sleeve member disposed around the jaws. Additionally, the wrench includes a push button assembly configured to move the sleeve member relative to the jaws, wherein the movement of the sleeve member causes the jaws to move between a retracted position and an extended position.

In another aspect, a method of operating a wrench is provided. The method includes the step of providing a wrench having a shaped handle with jaws operatively attached via pin members and a sleeve member disposed around the jaws. The method also includes the step of moving the sleeve member from an upper portion of the jaws to a lower portion of the jaws. Additionally, the method includes the step of rotating the jaws around the pin members from a retracted position to an extended position.

In a further aspect, a wrench is provided. The wrench includes a T-shaped body. The wrench further includes a plurality of jaws, wherein each jaw has an upper portion attached to the T-shaped body via a pin and a lower portion that includes a tapered surface. Additionally, the wrench includes a sleeve member disposed around the jaws, wherein the sleeve member has an inner surface that interacts with the tapered surface of the lower portion of each jaw when the sleeve member moves relative to the jaws.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a T-Handle wrench.

FIG. 2 is an exploded view of the T-Handle wrench.

FIG. 3 is a sectional view of the T-Handle wrench with jaws in a retracted position.

FIG. 4 is a sectional view of the T-Handle wrench with jaws in an extended position.

FIG. 5 is a view of the T-Handle wrench engaging an object.

### DETAILED DESCRIPTION

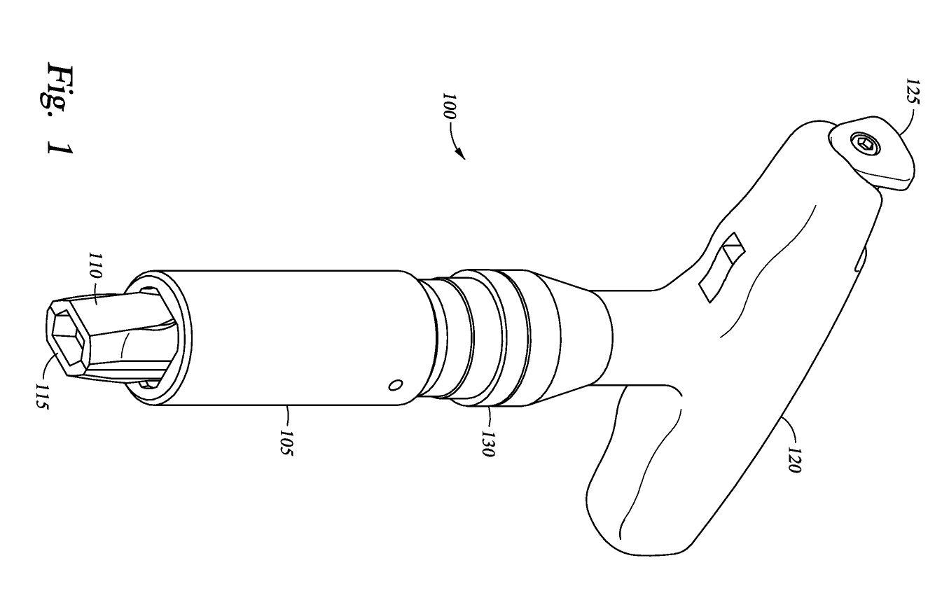

FIG. 1 is a perspective view of a T-Handle wrench 100. Generally, the T-Handle wrench 100 is configured to grip an object and then allow a user to apply a torque to the object. As shown, the T-Handle wrench 100 includes a handle 120, a push button 125, a collar member 130, a sleeve member 105 and jaws 110, 115. As will be described herein, a user will apply a force to the push button 125 which causes the sleeve member 105 to move away from the handle 120. As a result, a lower portion of the jaws 110, 115 will move radially outward to allow the T-Handle wrench 100 to grip the object, such as a bolt head.

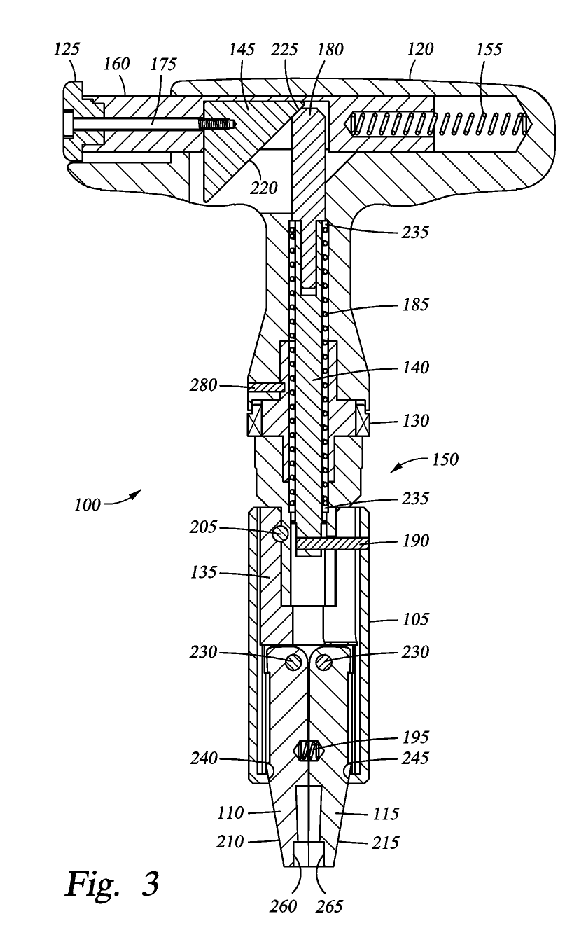

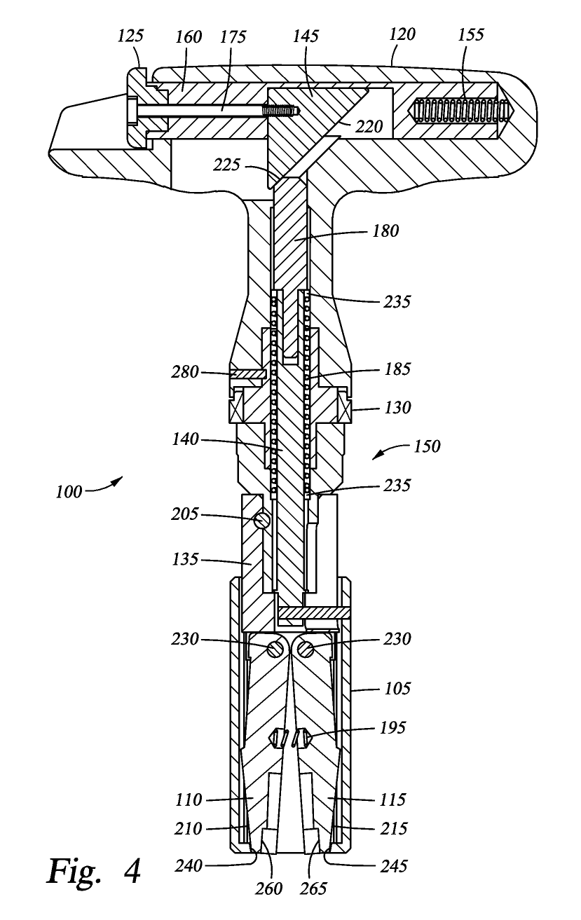

The jaws 110, 115 are movable between a retracted position (see FIG. 3) and an extended position (see FIG. 4). In the extended position, the jaws 110, 115 may be used to engage and grip the object. The jaws 110, 115 are also movable to any number of intermediate positions between the retracted position and the extended position. The intermediate positions allow the T-Handle wrench 100 to be used with a range of different sized objects (e.g. different sizes of bolt heads). The T-Handle wrench 100 in FIG. 1 shows two jaws, however, any number of jaws may be used without departing from the principles of the present invention.

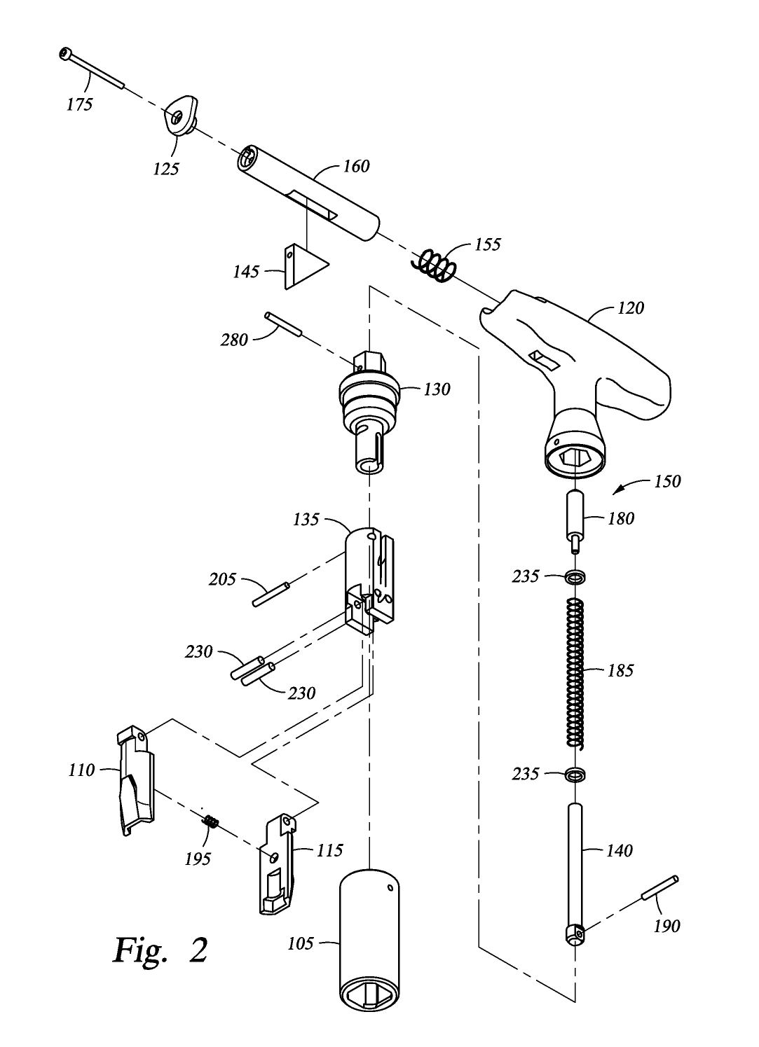

FIG. 2 is an exploded view of the T-Handle wrench 100. As shown, the T-Handle wrench 100 includes a push button assembly 150. Generally, the push button assembly 150 is used to move the sleeve member 105 relative to the jaws 110, 115. The sleeve member 105 is connected to the push button assembly 150 via connection member 190. The push button assembly 150 includes the push button 125, a handle rod 160, a wedge member 145 and a button biasing member 155 which are disposed in the handle 120. The push button 125, the handle rod 160 and the wedge member 145 are interconnected via connection member 175. The push button assembly 150 further includes an upper push rod 180, a lower push rod 140, a rod biasing member 185 and washers 235. The rod biasing member 185 is configured to bias the upper push rod 180 into engagement with the wedge member 145. In the embodiment illustrated the components of the push button assembly 150 and the sleeve member 105 move relative to the other components of the T-Handle wrench 100. As will be described herein, the components of the push button assembly 150 interact with the other components of the T-Handle wrench 100 to allow the jaws 110, 115 to move

The T-Handle wrench 100 further includes the collar member 130. Generally, the collar member 130 is a switch mechanism that allows the jaws 110, 115 to either rotate relative to the handle 120 or to be fixed relative to the handle 120. The collar member 130 is rotatable between a first position, a second position and a third position. In the first position, the jaws 110, 115 of the T-Handle wrench 100 are allowed to rotate relative to the handle 120 in a first direction and the jaws 110, 115 are fixed relative to the handle 120 in a second opposite direction. In the second position, the jaws 110, 115 of the T-Handle wrench 100 are fixed relative to the handle 120 in the first direction and the second opposite direction. In the third position, the jaws 110, 115 of the T-Handle wrench 100 are fixed relative to the handle 120 in the first direction and the jaws 110, 115 are allowed to rotate relative to the handle 120 in the second opposite direction. The collar member 130 is interconnected with a slide mechanism 135 via connection member 205 and the handle 120 via connection member 280.

FIG. 3 is a sectional view of the T-Handle wrench 100 with jaws 110, 115 in the retracted position. As shown, the jaws 110, 115 are held in the retracted position by the sleeve member 105. Specifically, the sleeve member 105 includes inner surfaces 240, 245 that are in contact with tapered surfaces 210, 215 of the jaws 110, 115 and the movement of the sleeve member 105 relative to the jaws 110, 115 controls rotational movement of the jaws 110, 115 around pins 230.

The interconnection of the components of the push button assembly 150 is also shown in FIG. 3. The push button 125, the handle rod 160, the wedge member 145 and the button biasing member 155 are disposed in the handle 120. The button biasing member 155 is configured to bias the wedge member 145 in a direction away from the upper push rod 180. The wedge block 145 includes a surface 220 that is configured to contact a surface 225 of the upper push rod 180. The movement of the push button 125 in a direction toward the upper push rod 180 compresses the button biasing member 155 and causes the surface 220 of the wedge block 145 to slide along the surface 225 of the upper push rod 180. As a result, the upper push rod 180 and the lower push rod 140 are urged away from the handle 120 and the rod biasing member 185 is compressed. The push rods 140, 180 are connected to the sleeve member 105 via connection member 190 and as such, the movement of the push rods 140, 180 causes the sleeve member 105 to move relative to the jaws 110, 115, thereby causing the tapered surfaces 210, 215 of jaws 110, 115 slide along the inner surfaces 240, 245 of the sleeve member 105. In turn, a biasing member 195 causes the jaws 110, 115 to rotate around the pins 230 to a desired position.

FIG. 4 is a sectional view of the T-Handle wrench with jaws in an extended position. As shown, the movement of the push button 125 in a direction toward the upper push rod 180 has compressed the button biasing member 155 and causes the surface 220 of the wedge block 145 to slide along the surface 225 of the upper push rod 180. As a result, the upper push rod 180 and the lower push rod 140 have been urged away from the handle 120 and the rod biasing member 185 is compressed. The movement of the push rods 140, 180 causes the sleeve member 105 to move away from the handle 120, thereby allowing the tapered surfaces 210, 215 of jaws 110, 115 slide along the inner surfaces 240, 245 of the sleeve member 105. At the same time, the jaws 110, 115 are biased outward by the biasing member 195 and rotate around the pins 230 to the desired position which may be the extended position or any number of intermediate positions.

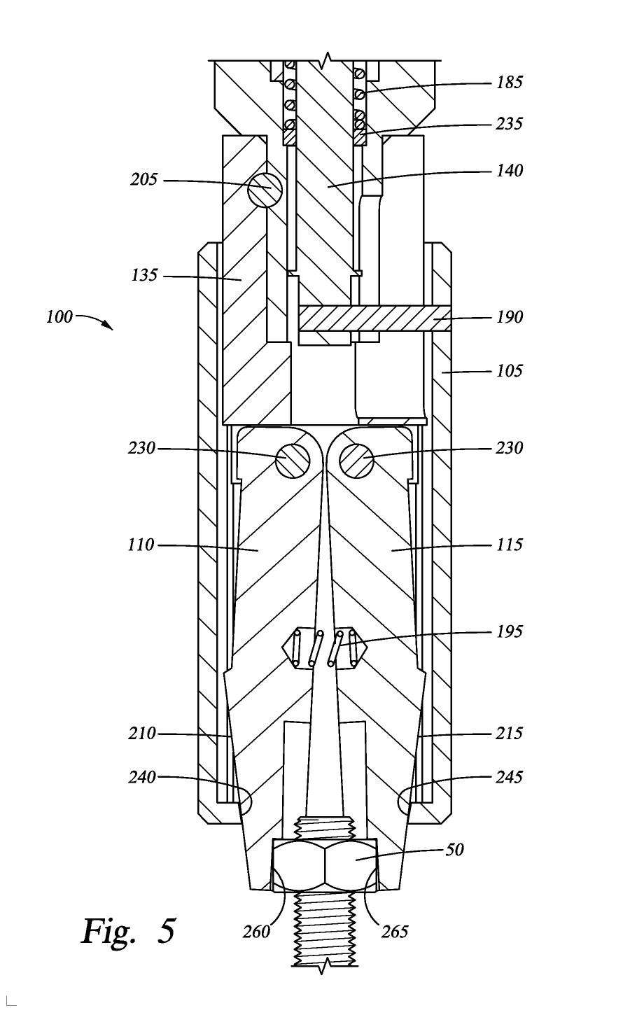

FIG. 5 is a view of the T-Handle wrench 100 engaging an object 50. The movement of the push rods 140, 180 causes the sleeve member 105 to move relative to the jaws 110, 115, thereby allowing the tapered surfaces 210, 215 of jaws 110, 115 slide along the inner surfaces 240, 245 of the sleeve member 105. At the same time, the jaws 110, 115 rotate around the pins 230 to the desired position. In one embodiment, the desired position is when the inner diameter of the jaws 110, 115 proximate the gripping surface 260, 265 is larger than the outer diameter of the object 50. Thereafter, the gripping surfaces 260, 265 of the jaws 110, 115 may be placed around the object 50 and the push button 125 is released. Upon release of the push button 125, the biasing member 155 moves the wedge member 145 away from the upper push rod 180 which causes the surface 220 of the wedge block 145 to slide along the surface 225 of the upper push rod 180. As a result, the upper push rod 180 and the lower push rod 140 are urged toward the handle 120 and the rod biasing member 185 expands. The push rods 140, 180 are connected to the sleeve member 105 via connection member 190 and as such, the movement of the push rods 140, 180 causes the sleeve member 105 to move toward the handle 120. As the sleeve member 105 moves toward the handle 120, the tapered surfaces 210, 215 of jaws 110, 115 slide along the inner surfaces 240, 245 of the sleeve member 105. In turn, the jaws 110, 115 rotate around the pins 230 to move the inner gripping surfaces 260, 265 of the jaws 110, 115 into engagement with the object 50. Thereafter, the user may apply a torque to the object by using the T-Handle wrench 100. The T-Handle wrench 100 may be disengaged from the object 50 by moving the jaws 110, 115 to the extended position in a similar manner as described herein.

While the foregoing is directed to embodiments of the present invention, other and further embodiments of the invention may be devised without departing from the basic scope thereof, and the scope thereof is determined by the claims that follow.

1. A wrench comprising:
a shaped handle;
a plurality of jaws operatively attached to the handle;
a sleeve member disposed around the jaws; and
a push button assembly configured to move the sleeve member relative to the jaws, wherein the movement of the sleeve member causes the jaws to move between a retracted position and an extended position.

2. The wrench of claim 1, further comprising a collar member disposed between the handle and the plurality of jaws, wherein the collar member is configured to control a direction of rotation of the plurality of jaws relative to the shaped handle.

3. The wrench of claim 1, wherein the push button assembly includes a push button, a wedge block and a push rod disposed in the shaped handle.

4. The wrench of claim 3, wherein a first portion of the push rod is in contact with the wedge block and a second portion of the push rod is connected to the sleeve member.

5. The wrench of claim 4, wherein the activation of the push button causes the wedge block to move the push rod away from the handle.

6. The wrench of claim 5, wherein the movement of the push rod causes the sleeve member to move relative to the plurality of jaws.

7. The wrench of claim 1, wherein each jaw has an upper portion attached to the handle via a pin and a lower portion that includes a tapered surface.

8. The wrench of claim 7, wherein each jaw rotates around the respective pin to the extended position as the sleeve member moves from the upper portion of the jaw to the lower portion of the jaw.

9. The wrench of claim 7, wherein each jaw rotates around the respective pin to the retracted position as the sleeve member moves from the lower portion of the jaw to the upper portion of the jaw.

10. The wrench of claim 7, wherein the sleeve member includes an inner surface that interacts with the tapered surface of the lower portion of the jaw as the sleeve moves relative to the jaw.

11. The wrench of claim 1, wherein the jaws are biased in the extended position by a biasing member.

12. A method of operating a wrench, the method comprising:
providing a wrench having a shaped handle with jaws operatively attached via pin members and a sleeve member disposed around the jaws; and
moving the sleeve member from an upper portion of the jaws to a lower portion of the jaws, thereby moving the jaws from a retracted position to an extended position.

13. The method of claim 12, further comprising moving the sleeve member from the lower portion of the jaws to the upper portion of the jaws, thereby causing the jaws to rotate around the pin members from the extended position to the retracted position.

14. The method of claim 12, further comprising positioning the jaws around an object when the jaws are in the extended position.

15. The method of claim 14, further comprising gripping the object by moving the sleeve member from the lower portion of the jaws to the upper portion of the jaws.

16. The method of claim 12, further comprising moving the jaws to an intermediate position by moving the sleeve member along a portion of the jaws.

17. A wrench comprising:
a T-shaped body;
a plurality of jaws, wherein each jaw has an upper portion attached to the T-shaped body via a pin and a lower portion that includes a tapered surface; and
a sleeve member disposed around the jaws, wherein the sleeve member has an inner surface that interacts with the tapered surface of the lower portion of each jaw when the sleeve member moves relative to the jaws.

18. The wrench of claim 17, wherein each jaw rotates around the respective pin to an extended position as the sleeve member moves from the upper portion of the jaw to the lower portion of the jaw.

19. The wrench of claim 17, wherein each jaw rotates around the respective pin to a retracted position as the sleeve member moves from the lower portion of the jaw to the upper portion of the jaw.

20. The wrench of claim 17, further comprising a collar member disposed between the T-shaped body and the plurality of jaws, wherein the collar member is configured to control a direction of rotation of the plurality of jaws relative to the T-shaped body.
